(19) United States
(12) Patent Application Publication
(10) Pub. No.: US 2015/0067761 A1
(43) Pub. Date: Mar. 5, 2015

(54) MANAGING SECURITY AND COMPLIANCE OF VOLATILE SYSTEMS

(71) Applicant: International Business Machines Corporation, Armonk, NY (US)

(72) Inventors: Steven A. Bade, Georgetown, TX (US); Heather M. Hinton, Austin, TX (US); Neil I. Readshaw, Parkwood (AU)

(73) Assignee: International Business Machines Corporation, Armonk, NY (US)

(21) Appl. No.: 14/013,557

(22) Filed: Aug. 29, 2013

(51) Int. Cl. H04L 29/06

(52) U.S. Cl. CPC H04L 63/20
USPC 726/1

(57) ABSTRACT

An inventory manager optimizes the security and maintenance of a plurality of virtual machines and their workloads in a cloud environment and has: an inventory database, a workload compliance history of scanning workloads database, and a workload category database including security rules and compliance policies relating to workload category in a repository. The inventory manager identifies changes to characteristics of the workload of the plurality of virtual machines; alters the inventory database stored in the repository and maintained by the inventory manager, based on the identified changes to the characteristics of the workload of the plurality of virtual machines; and initiates security rules and compliance policies of the workload category database based on the identified changes to the characteristics of the workload of the plurality of virtual machines through a security tools program.

### BACKGROUND

The present invention relates to volatile computer systems, and more specifically to management of security and compliance of volatile systems.

In traditional non-virtualized, single tenant environments, a number of systems exist for maintaining system inventory and trigger security and compliance activities. One example of such as system is a configuration management database (CMDB).

Security and compliance management of virtual machines (VMs) in cloud computing is more difficult than management of physical servers or in a non-virtualized, single tenant environment. The difficulty can be attributed to the fact that virtual machine lifecycle operations are frequently more transient, with the virtual machines being spun up and wound down based on workload or capacity needs.

In a cloud computing environment, a user is assigned a virtual machine somewhere in the computing cloud. The virtual machine provides the software operating system and has access to shared physical resources to support the user's application, such as input/output bandwidth, processing power and memory capacity. Provisioning software manages and allocates virtual machines among the available computer nodes in the cloud. Because each virtual machine runs independent of other virtual machines, multiple operating system environments can co-exist on the same physical computer in complete isolation from each other.

A virtual machine and its given IP address may be associated with more than one tenant over time in a shared, public cloud, and the virtual machine's compliance policy may change with each tenant and/or cloud. The interval in which the virtual machine may be associated with one tenant may be as little as fifteen minutes. Furthermore, the duration of the lifetime of a virtual machine may affect the security and compliance policies. For example if VM originally created for a demonstration continues to run, the probability increases that a user may begin to use it for a different, more strategic purpose.

Within cloud architecture BSS/OSS (Business and Operations Support System) stacks are used to orchestrate VM lifecycle operation.

### SUMMARY

According to one embodiment of the present invention a method for optimizing the security and maintenance of a plurality of virtual machines and their workloads with an inventory manager. The inventory manager comprising an inventory database, a workload compliance history of scanning workloads database, and a workload category database including security rules and compliance policies relating to workload category in a repository. The method comprising: the inventory manager identifying changes to characteristics of the workload of the plurality of virtual machines; the inventory manager altering the inventory database stored in the repository and maintained by the inventory manager, based on the identified changes to the characteristics of the workload of the plurality of virtual machines; and the inventory manager initiating security rules and compliance policies of the workload category database based on the identified changes to the characteristics of the workload of the plurality of virtual machines through a security tools program of the cloud computing environment.

### BRIEF DESCRIPTION OF THE SEVERAL VIEWS OF THE DRAWINGS

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 is shows an example of interaction between the volatile inventory manager of an embodiment of the present invention within the cloud computing environment.

FIG. 5 shows the volatile inventory manager of an embodiment of the present invention.

FIG. 6 shows a flowchart of a method of a volatile inventory manager applying security and compliance rules to a newly created workload.

FIG. 7 shows a flowchart of a method of a volatile inventory manager deleting a workload from the volatile inventory manager.

FIG. 8 shows a flowchart of a method of a volatile inventory manger applying security/compliance rules and policies to a suspended workload.

FIG. 9 shows a flowchart of a method of a volatile inventory manager applying security/compliance rules and policies to steady state processing of a workload.

FIG. 10 shows a flowchart of a method of a volatile inventory manager applying security/compliance rules and policies to a workload with a manually changed usage category.

### DETAILED DESCRIPTION

In an illustrative embodiment of the present invention, the inclusion of a volatile inventory manager allows for the reuse of existing system inventory tools and processes designed for relatively static environments within the cloud/virtualization environment. Furthermore, an illustrative embodiment of the present invention allows for the reuse of existing security/compliance tools designed for a static environment within a transient, dynamic environment without changes to the tools themselves.

In an illustrative embodiment of the present invention, characteristics of a workload of a virtual machine may include, the creation time of a workload, the workload category, the manually change of, the status of the workload (active, suspended), the timestamps or other such activity of the workload, and the deletion of the workload. The timestamps may relate to the time frame in which the workload has been active for. The timestamp may be compared to a predetermined range of time.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

It will be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

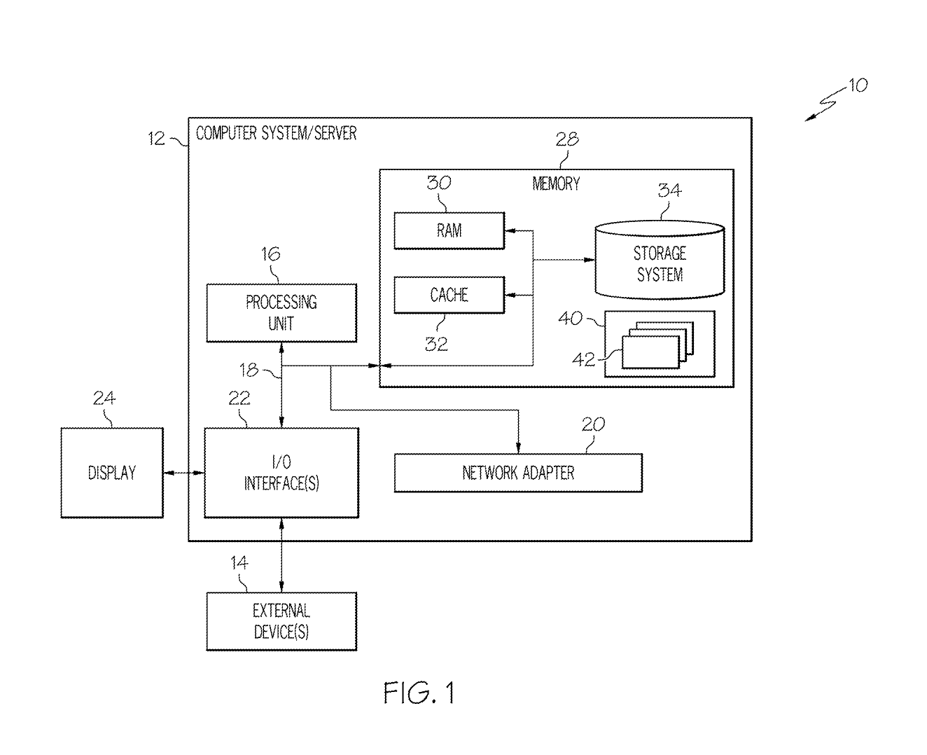

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

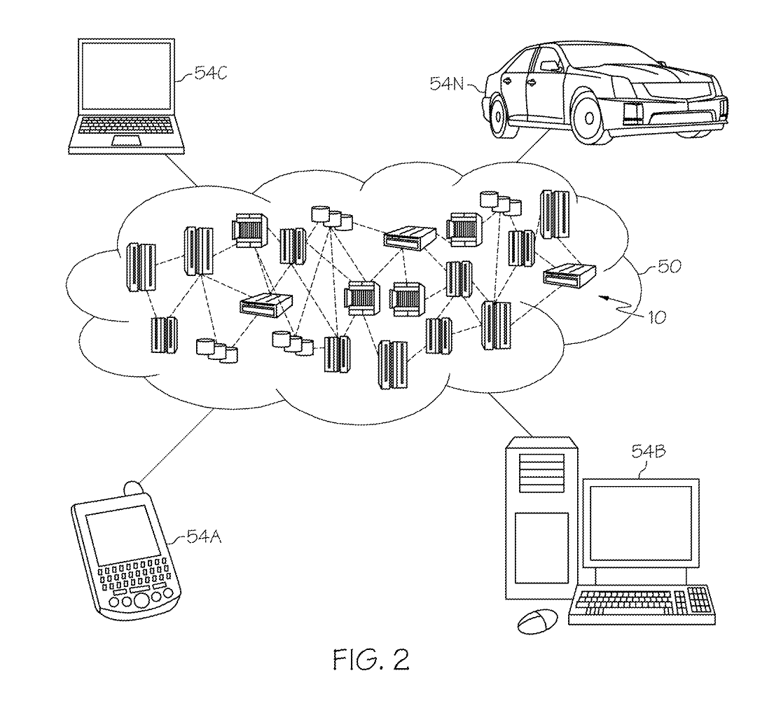

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

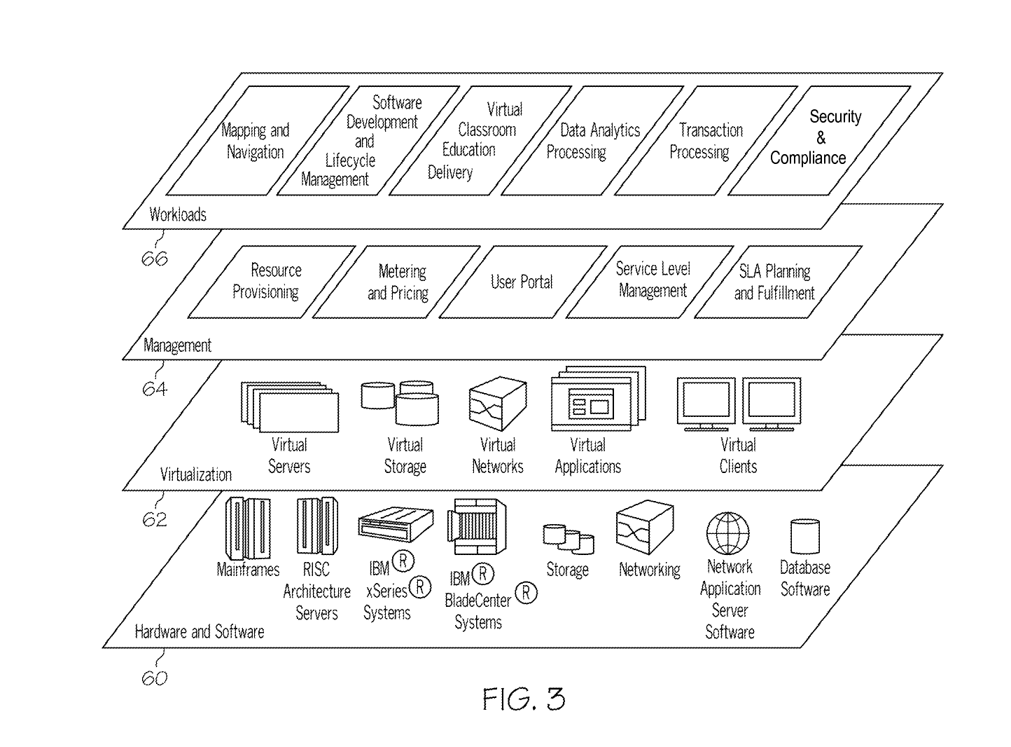

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and security and compliance.

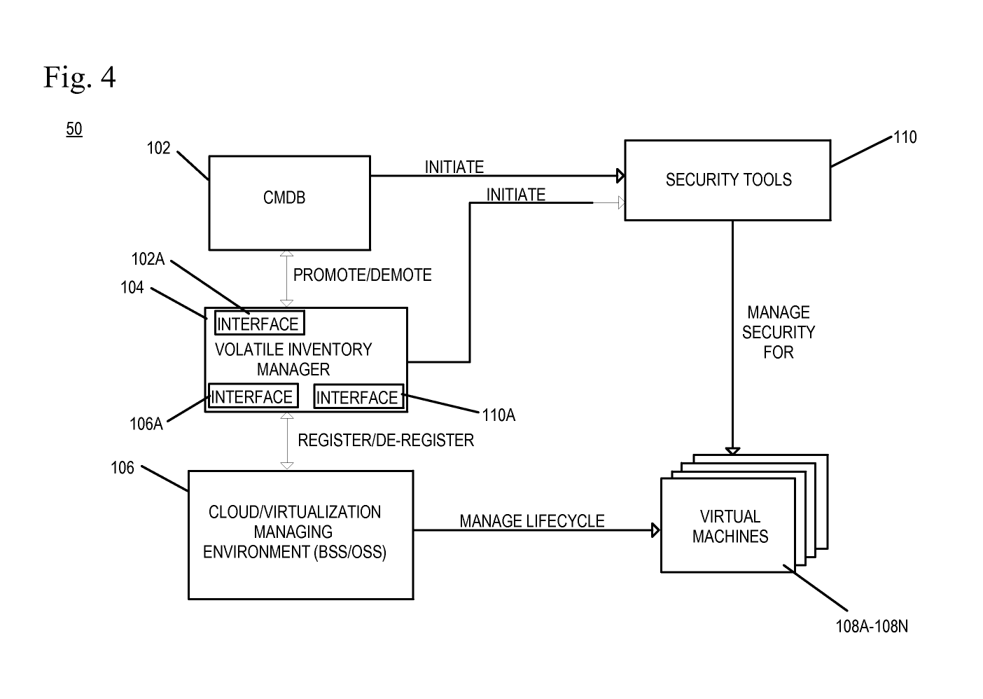

FIG. 4 shows an example of interaction between the volatile inventory manager of an embodiment of the present invention within the cloud computing environment. Within the cloud computing environment 50, a configuration management database (CMDB) 102 initiates security tools 110 within the environment 50, for example through an interface 110A of the volatile inventory manager 104. Security tools 110, represented in FIG. 4 as a single box may be representative of numerous security tools such as a vulnerability scanner, patch management security configuration checking and other such security measures. The security tools 110 manage security for virtual machines (VMs) 108a-108n within the cloud computing environment 50. The lifecycle of the VMs 108a-108n is managed by the cloud/virtualization managing environment software 106. A volatile inventory manager 104 maintains an inventory of systems based on their IT lifecycle; optimizes the maintenance of the inventory of the systems for dynamic, multi-tenant, virtualized cloud environments; and optimizes the integration of security and compliance tools in the cloud computing environment 50. The volatile inventory manager 104 has interfaces 102A, 106A and 110A for communicating with the CMDB, the cloud/virtualization managing environment software 106 and various security tools 110. It should be noted that different security tools within the representative “security tools” box of 110 may offer a standardized interface or each security tool itself may have an interface for communication with the CMDB and the volatile inventory manager 104.

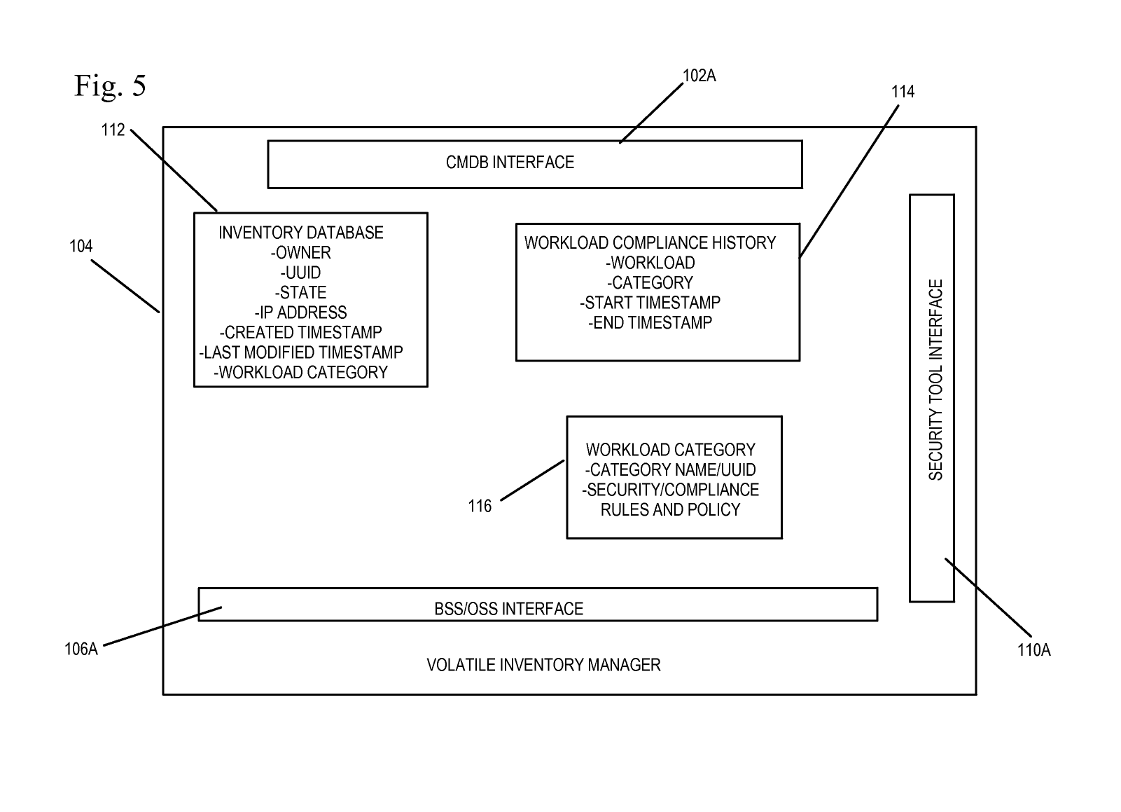

Referring to FIG. 5, the inventory of the systems and virtual machines within the cloud computing environment is maintained in an inventory database 112 preferably including information regarding owner, universally unique identifier (UUID), state (e.g. active/suspended), IP address, created timestamp, last modified timestamp, workload category. The workload compliance history 114 of the volatile inventory manager 104 optimizes the maintenance of the inventory of the systems for dynamic, multi-tenant, virtualized cloud environments by tracking workload, category, start and end timestamp. The workload category 116 of the volatile inventory manager 104 optimizes the integration of security and compliance tools in the cloud computing environment through the category name/UUID of systems within the cloud computing environment and the security and compliance rules and policies. The security and compliance rules are the rules defined to describe events and actions in how the workload is managed within the inventory of the cloud computing environment. The rules may be expressed through a business processing language such as, for example, Business Process Execution Language (BPEL).

Referring back to FIG. 4, the volatile inventory manager 104 initiates security tools 110 through the security tools interface 110a, promotes or demotes configuration items (CI) of the CMDB 102 through the CMDB interface 102a, and registers or deregisters BSS/OSS stacks of the cloud/virtualization managing environment software 106 through the cloud/virtualization managing environment interface 106a.

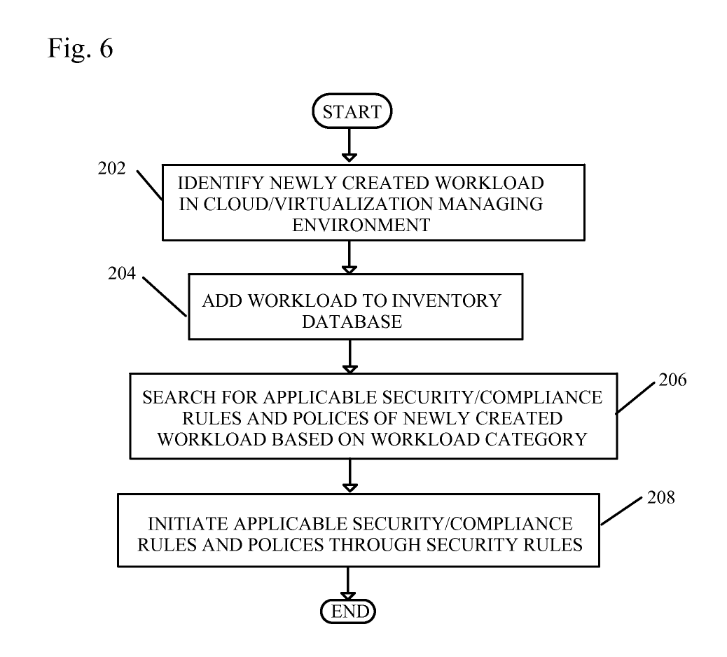

FIG. 6 shows a flowchart for a method of a volatile inventory manager applying security and compliance rules to a newly created workload. The volatile inventory manager 104 identifies that a new workload has been created in the cloud/virtualization managing environment 106. The identification may take place through a notification from the cloud/virtualization managing environment 106 or some other mechanism such as notification protocol, agent in the virtual machine, application programming interface (API), or representational state transfer (REST). When the new workload was created, it was assigned an initial workload category either manually by a user or via selection of a template image on which the new workload was created in the cloud/virtualization managing environment 106 (step 202).

The volatile inventory manager 104 adds the newly created workload to or registers the created workload into its inventory database 112 (step 204).

The volatile inventory manager 104 searches for the security/compliance rules and policies which are associated with the initially assigned workload category of the newly created workload based in the workload category 116 of the volatile inventory manager 104 (step 206).

The volatile inventory manager 104 initiates the security/compliance rules and policies which apply to the newly created workload through the security rules 110 (step 208).

For example, the workload category may be DEV/TEST (development/testing) and the following security/compliance rules and policies may apply:

Workload Category: DEV/TEST

1. At creation time or workload category change, performance security configuration scan using endpoint management technology and ‘DEV/TEST’ policy. An example of an endpoint management technology that may be used is IBM Endpoint Manager®.
2. Scan against ‘DEV/TEST’ policy weekly. In another embodiment, the ‘DEV/TEST’ policy would be opaque to the volatile inventory manager 104 and CMDB and may have less security measures than a production policy.
3. Upon restore from snapshot or suspennsion, scan immediately.

Workload Category: PRODUCTION

1. At workload creation, enable security auditing or other security configuration per ‘Production policy’.

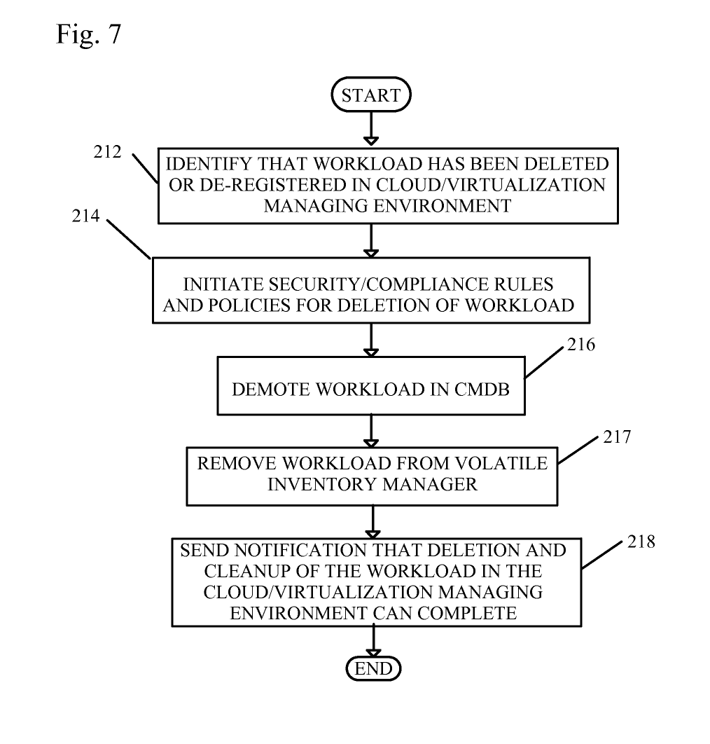

FIG. 7 shows a flowchart for a method of a volatile inventory manager deleting a workload from the volatile inventory manager. The volatile inventory manager 104 identifies that a workload has been deleted or de-registered in the cloud/virtualization managing environment 106 (step 212). The identification may take place through a notification from the cloud/virtualization managing environment 106 or some other mechanism such as notification protocol, agent in the virtual machine, application programming interface (API), or representational state transfer (REST).

The volatile inventory manager 104 initiates the security/compliance rules and policies for deletion of a workload through the security tools 110 (step 214).

The following security/compliance rules and policies may apply:

Workload Category: PRODUCTION

1. At workload deletion, scan for confidential data using data loss prevention (DLP) technology.

Once the security/compliance rules and policies for deletion of a workload through the security tools 110 is complete, the volatile inventory manager 104 demotes the workload in the CMDB 102 (step 216), removes the workload from the volatile inventory manager 104 (step 217), and sends a notification that deletion and cleanup in the cloud/virtualization managing environment can complete (step 218).

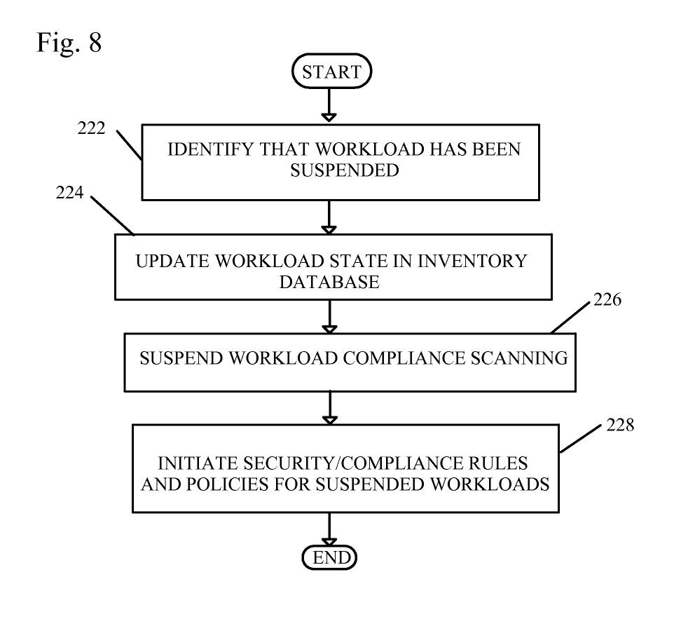

FIG. 8 shows a flowchart of a method of a volatile inventory manger applying security/compliance rules and policies to a suspended workload. The volatile inventory manager 104 identifies that a workload has been suspended in the cloud/virtualization managing environment 106 (step 222). The identification may take place through a notification from the cloud/virtualization managing environment 106 or some other mechanism such as notification protocol, agent in the virtual machine, application programming interface (API), or representational state transfer (REST). Furthermore, the identification of the suspended workload may come from a security scan executed by the security tools 110.

The volatile inventory manager 104 updates the workload state within the inventory database (step 224). The volatile inventory manager 104 suspends the workload compliance scanning and initiates the security/compliance rules and policies for suspended workloads through the security rules 110.

For example, the following security/compliance rules and policies may apply:

Workload Category: DEMO

1. If workload lifetime is greater than 4 hours, then Workload Category->DEV/TEST
2. If security scan result=CRITICAL then shutdown workload and notify owner.

Workload Category: PRODUCTION

1. If security scan result=CRITICAL, then notify business owner and technical owner, create problem ticket.
2. If workload lifetime is greater than 2 days, move Workload to CMDB.

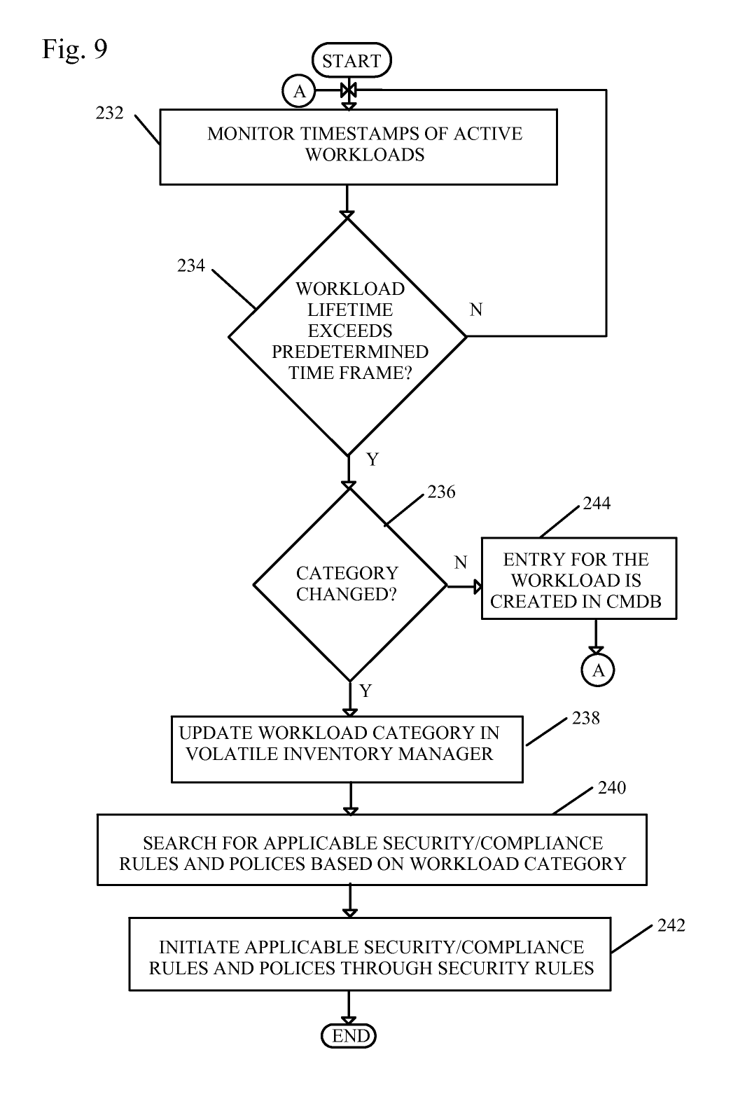

FIG. 9 shows a flowchart of a method of a volatile inventory manager applying security/compliance rules and policies to steady state processing of a workload. The volatile inventory manager 104 monitors timestamps of active workloads (step 232), for example through the workload compliance history 114.

If the workload lifetime exceeds a predetermined time frame (step 234), and the workload category changed (step 236), then the workload category is updated in the volatile inventory manager (step 238), for example the inventory database 112, the workload category 116 and the workload compliance history 114.

The volatile inventory manager 104 then searches for applicable security/compliance rules and policies based on the updated the workload category (step 240).

The volatile inventory manager 104 then initiates applicable security/compliance rules and policies based on the updated workload category through the security tools 110 (step 242).

For example, the following security/compliance rules and policies may apply:

Workload Category: DEMO

1. If workload lifetime is greater than 4 hours, then Workload Category->DEV/TEST

Workload Category: PRODUCTION

2. If workload lifetime is greater than 2 days, move Workload to PRODUCTION.

If the workload lifetime does not exceed a predetermined time frame (step 234), then the method returns to step 232 of monitoring timestamps of active workloads.

If the workload lifetime exceeds a predetermined time frame (step 234), and the workload category did not change (step 236), then an entry for the workload is created in the CMDB (step 244) and the method returns to step 232 of monitoring the time stamps of active workloads. When the workload is created in the CMDB, a pointer record may be retained within the inventory database of the volatile inventory manager 104 to point to the record created in the CMDB.

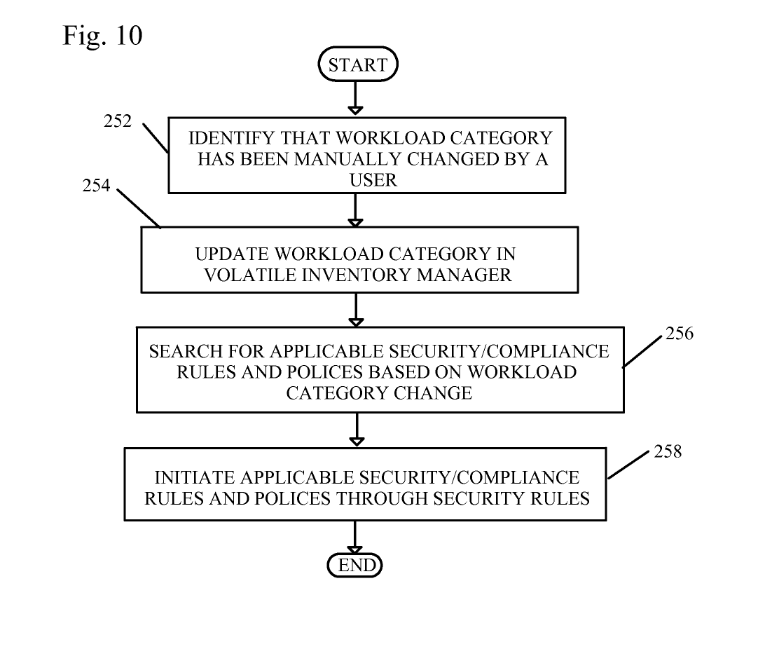

FIG. 10 shows a flowchart of a method of a volatile inventory manager applying security/compliance rules and policies to a workload with a manually changed usage category.

The volatile inventory manager 104 identifies that the workload category in the cloud/virtualization managing environment 106 has been manually changed by a user (step 252). The identification may take place through a notification from the cloud/virtualization managing environment 106 or some other mechanism such as notification protocol, agent in the virtual machine, application programming interface (API), or representational state transfer (REST). Furthermore, the identification of the workload category change may come from a security scan executed by the security tools 110.

The volatile inventory manager 104 updates the workload category in the volatile inventory manager (step 254), for example the inventory database 112, the workload category 116 and the workload compliance history 114.

The volatile inventory manager 104 then searches for applicable security/compliance rules and policies based on the updated the workload category (step 256).

The volatile inventory manager 104 then initiates applicable security/compliance rules and policies based on the updated workload category through the security tools 110 (step 258).

For example, the following security/compliance rules and policies may apply:

Workload Category: DEV/TEST

1. At creation time or workload category change, performance security configuration scan using endpoint management technology and ‘DEV/TEST’ policy. An example of an endpoint management technology that may be used is IBM Endpoint Manager®.
2. Scan against ‘DEV/TEST’ policy weekly.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Aspects of the present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method for optimizing the security and maintenance of a plurality of virtual machines and their workloads with an inventory manager comprising an inventory database, a workload compliance history of scanning workloads database, and a workload category database including security rules and compliance policies relating to workload category in a repository, the method comprising:
the inventory manager identifying changes to characteristics of the workload of the plurality of virtual machines;
the inventory manager altering the inventory database stored in the repository and maintained by the inventory manager, based on the identified changes to the characteristics of the workload of the plurality of virtual machines; and
the inventory manager initiating security rules and compliance policies of the workload category database based on the identified changes to the characteristics of the workload of the plurality of virtual machines through a security tools program.

2. The method of claim 1, wherein the identified changes to the characteristics of the workload of the plurality of virtual machines are identified as creation of a new workload in a virtualization managing environment managing the plurality of the virtual machines within a cloud computing environment.

3. The method of claim 2, wherein the step of the inventory manager altering the inventory database stored in the repository further comprises the steps of: the inventory manager storing the new workload in the inventory database.

4. The method of claim 2, wherein the step of the inventory manager initiating security rules and compliance policies of the workload category database based on the identified changes to the characteristics of the workload further comprises the steps of: the inventory manager searching the workload category database stored in the repository and maintained by the inventory manager for applicable security rules and compliance polices.

5. The method of claim 1, wherein the identified changes to the characteristics of the workload of the plurality of virtual machines are identified as a suspended workload.

6. The method of claim 5, wherein the step of the inventory manager altering the inventory database stored in the repository and maintained by the inventory manager, based on the identified changes to the characteristics of the workload of the plurality of virtual machines further comprises the steps of: the inventory manager updating the state of the workload in the inventory database and suspending maintenance of the workload within the workload compliance history of scanning workloads database.

7. The method of claim 1, wherein the identified changes to the characteristics of the workload of the plurality of virtual machines are identified as a workload lifetime exceeding a predetermined time frame.

8. The method of claim 7, wherein the step of the inventory manager identifying changes to characteristics of the workload of the plurality of virtual machines further comprises the step of the inventory manager determining whether the workload category has changed for the workload that has the workload lifetime that has exceeding the predetermined time frame.

9. The method of claim 8, wherein if the workload category has changed, the step of the inventory manager altering the inventory database stored in the repository and maintained by the inventory manager, based on the identified changes to the characteristics of the workload of the plurality of virtual machines further comprises the step of the inventory manager altering the workload category in the inventory database.

10. The method of claim 8, wherein if the workload category has changed, the step of the inventory manager initiating security rules and compliance policies of the workload category database based on the identified changes to the characteristics of the workload of the plurality of virtual machines through a security tools program further comprises the steps of: the inventory manager searching the workload category database stored in the repository and maintained by the inventory manager for applicable security rules and compliance polices.

11. The method of claim 8, wherein if the workload category has remained the same as present in the inventory database, creating an entry for the workload in a configuration management database stored in a repository of a cloud computing environment.

12. The method of claim 1, wherein the identified changes to the characteristics of the workload of the plurality of virtual machines are identified as a manual change to a workload category of the workload by a user.

13. The method of claim 12, wherein the step of the inventory manager altering the inventory database stored in the repository further comprises the steps of: the inventory manager updating the workload category of a workload in the inventory database.

14. The method of claim 12, wherein the step of the inventory manager initiating security rules and compliance policies of the workload category database based on the identified changes to the characteristics of the workload further comprises the steps of: the inventory manager searching the workload category database stored in the repository and maintained by the inventory manager for applicable security rules and compliance polices.

15. The method of claim 1, wherein the identified changes to the characteristics of the workload of the plurality of virtual machines are identified as a deletion of a workload within the virtualization managing environment of the cloud computing environment.

16. The method of claim 15, further comprising the step of the inventory manager demoting the workload within a configuration management database stored in a repository of a cloud computing environment.

17. The method of claim 15, further comprising the step of removing the workload from the inventory database stored in the repository.

18. The method of claim 15, wherein the step of the inventory manager initiating security rules and compliance policies of the workload category database based on the identified changes to the characteristics of the workload of the plurality of virtual machines through a security tools program further comprises the inventory manager sending a notification to the virtualization managing environment of the cloud computing environment to allow for deletion and cleanup of the deleted workload.
